(19) United States
(12) Patent Application Publication
(10) Pub. No.: US 2008/0021897 A1
(43) Pub. Date: Jan. 24, 2008

(54) Techniques for detection of multi-dimensional clusters in arbitrary subspaces of high-dimensional data

(75) Inventor: Jorge O. Lepre, Hastings-on-Hudson, NY (US)

Correspondence Address: Michael J. Chang, LLC, 84 Summit Avenue, Milford, CT, 06460, US

(73) Assignee: International Business Machines Corporation, Armonk, NY (US)

(21) Appl. No.: 11/489,083

(22) Filed: Jul. 19, 2006

(51) Int. Cl. G06F 17/30

(52) U.S. Cl. 707/6

(57) ABSTRACT

Clustering techniques for data analysis are provided. In one aspect, a method for finding clusters in a database containing a plurality of input attributes associated with a plurality of samples is provided. The method comprises the following steps. One-dimensional clusters are detected for each of one or more of the input attributes in the database. The one-dimensional clusters are used to determine one or more subspaces wherein at least one multi-dimensional cluster of the samples can exist. One or more multivariate clusters are detected in the one or more subspaces. Each input attribute, e.g., a gene, may comprise one or more values corresponding to one or more of the samples, e.g., medical patients, in the database.

### FIELD OF THE INVENTION

The present invention relates to data analysis, and more particularly, to clustering techniques for data analysis.

### BACKGROUND OF THE INVENTION

Clustering is a common data mining technique. The objective of clustering is to find and cluster sets of data points that are similar to each other and that can be clearly distinguished from data points outside of the cluster. Clustering techniques are used extensively in statistics, pattern recognition and machine learning.

To perform a clustering analysis, the analyst is typically required to make a number of preliminary choices, such as the particular clustering method to use and its parameters. One of the most difficult choices the analyst has to make involves picking the dimensions and/or the attributes to use for clustering the data.

High throughput measurement technologies, such as gene expression microarrays, produce sample points characterized by tens of thousands of dimensions. For this kind of very high-dimensional data, it is beneficial to have clustering methods that can properly select subsets of dimensions (especially since many of the dimensions reported are likely to be uninformative).

Each subset of dimensions defines a subspace wherein high quality clusters may be found. The problem of finding clusters and their relevant subspaces is typically referred to as “subspace clustering.” Subspace clustering methods are described, for example, in L. Parsons et al., Subspace Clustering For High Dimensional Data: A Review, SIGKDD Explorations, Newsletter of the ACM Special Interest Group on Knowledge Discovery and Data Mining, 6(1):90 (2004), the disclosure of which is incorporated by reference herein.

A primary goal of subspace clustering is to find all subspaces that contain meaningful clusters. This can be a complex task due to the fact that different subspaces can cluster points differently, clusters of points from one subspace can overlap with clusters from another and subspaces need not be disjoint with one another. Hence, it is expected that subspace clustering will be most useful for clustering heterogeneous data sets.

To perform subspace clustering, the nature of the clusters to be found must first be defined. For example, in J. Lepre et al., Genes@Work: An Efficient Algorithm For Pattern Discovery and Multivariate Feature Selection In Gene Expression Data, BIOINFORMATICS, 20(7):1033 (2004) (hereinafter “Lepre”), the disclosure of which is incorporated by reference herein, subspace clusters (also referred to as “patterns”) are defined as a subset of attributes such that a subset of the sample points exists satisfying the property that all (properly normalized) attribute values in a cluster fall into an interval of width δ, wherein δ is a user-selected parameter. These clusters can be found exhaustively and efficiently by a combinatorial search algorithm.

The approach of Lepre, however, may not be practical for certain classes of large data sets for which an extremely large number of clusters are reported. Namely, the vast majority of the clusters reported are uninformative, as they are random variations of a core cluster, and are hence redundant. The core cluster is the cluster of most interest. However, attempts to detect the core cluster from its random redundant variations have so far been impractical.

The inability to detect the core cluster arises from the difficulty in assessing how many random variations are needed to describe the core cluster and the sheer number of such random variations. This problem increases exponentially as the number of samples in the data sets is increased.

Therefore, subspace clustering techniques that filter out redundant random variations, and thus provide only non-redundant clusters in large data sets, such as those generated by gene expression microarrays, would be desirable.

### SUMMARY OF THE INVENTION

The present invention provides clustering techniques for data analysis. In one aspect of the invention, a method for finding clusters in a database containing a plurality of input attributes associated with a plurality of samples is provided. The method comprises the following steps. One-dimensional clusters are detected for each of one or more of the input attributes in the database. The one-dimensional clusters are used to determine one or more subspaces wherein at least one multi-dimensional cluster of the samples can exist. One or more multivariate clusters are detected in the one or more subspaces. Each input attribute, e.g., a gene, may comprise one or more values corresponding to one or more of the samples, e.g., medical patients, in the database.

In another aspect of the invention, a method for finding Gaussian clusters in a database containing a plurality of input attributes associated with a plurality of samples is provided. The method comprises the following steps. One-dimensional Gaussian clusters are detected for each of one or more of the input attributes in the database. The one-dimensional Gaussian clusters are used to determine one or more subspaces wherein at least one multi-dimensional Gaussian cluster of the samples can exist. One or more multivariate Gaussian clusters are detected in the one or more subspaces.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary methodology for finding clusters in a database according to an embodiment of the present invention;

FIG. 2 is a diagram illustrating an exemplary synthetic data set according to an embodiment of the present invention;

FIG. 3 is a plot illustrating optimal mixture densities for each attribute of the exemplary data set of FIG. 2 according to an embodiment of the present invention;

FIG. 4 is a diagram illustrating clustering of elementary patterns in a pattern space by an auxiliary clustering procedure according to an embodiment of the present invention;

FIGS. 5A-C are plots illustrating multi-dimensional Gaussian mixtures for the candidate subspaces shown identified in FIG. 4 according to an embodiment of the present invention; and

FIG. 6 is a diagram illustrating an exemplary system for finding clusters in a database according to an embodiment of the present invention.

### DETAILED DESCRIPTION OF PREFERRED EMBODIMENTS

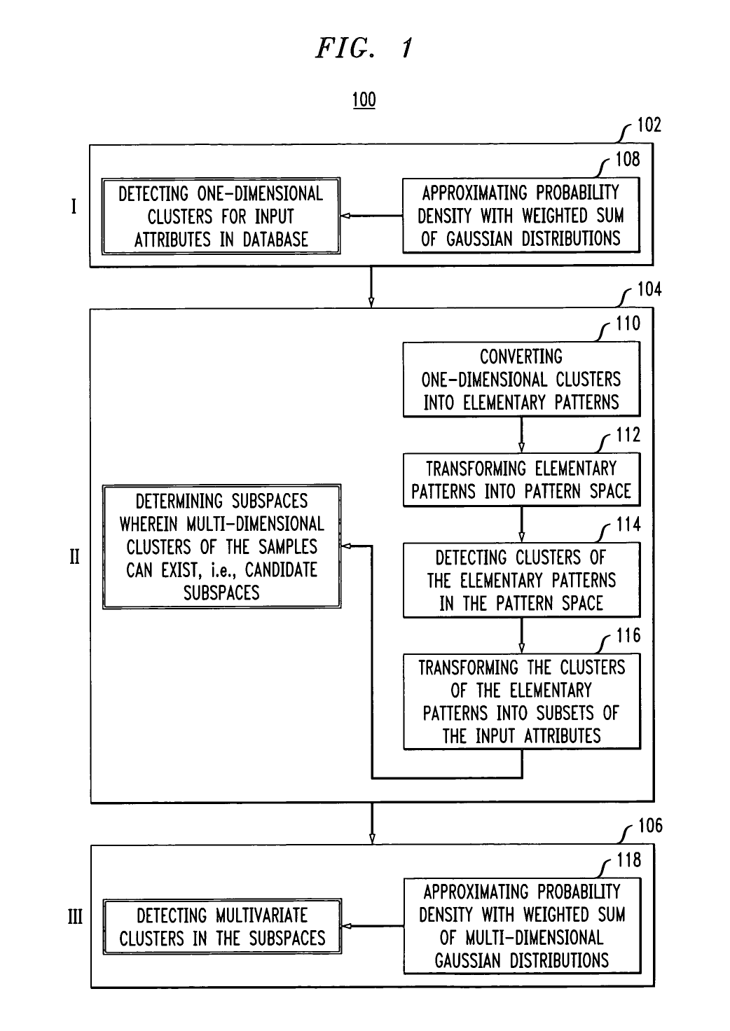

FIG. 1 is a diagram illustrating exemplary methodology 100 for finding clusters in a database. The database contains a plurality of input attributes associated with a plurality of samples. Namely, the input attributes can include values corresponding to one or more of the samples in the database. According to one exemplary embodiment, the input attributes comprise genes and the samples comprise medical patients in the database. The techniques presented herein should not, however, be limited to any particular data type or database set.

As shown in FIG. 1, methodology 100 includes a first phase, a second phase and a third phase, i.e., phases 102, 104 and 106, respectively. As will be described in detail below, in the first phase (phase 102), one-dimensional Gaussian clusters are detected for each and all of the input attributes in the database. In the second phase (phase 104), subspaces are determined wherein multi-dimensional Gaussian clusters of the samples can exist, i.e., candidate subspaces. In the third phase (phase 106), multivariate clusters are detected in the candidate subspaces. For ease of reference, the following description of methodology 100 will be divided into the following sections: (I) First Phase, (II) Second Phase and (III) Third Phase.

### I. First Phase

As described above, in phase 102, the first phase of methodology 100, one-dimensional Gaussian clusters, e.g., one-dimensional Gaussian mixtures, are detected for each and all of the input attributes in the database. According to an exemplary embodiment, as shown in step 108, the one-dimensional Gaussian mixtures can be detected by approximating a probability density of the values, or a transformation of the values, of each input attribute as a weighted sum of Gaussian distributions.

By way of example only, the input attributes are assumed to be continuous and real valued, and the probability density of each input attribute (i.e., independently from the other input attributes) is estimated by a Gaussian mixture model. The Gaussian mixture model assumes that the probability density of x is of the form:

$$\begin{matrix}p ( x ) = {\sum }_{k = 1}^{M} {λ}_{k} N ( x \vert {μ}_{k} , {σ}_{k} ) , \\ wherein & ( 1 ) \\ N ( x \vert {μ}_{k} , {σ}_{k} ) = \frac{exp ( - {( x - {μ}_{k} )}^{2} / ( 2 {σ}_{k}^{2} ) )}{\sqrt{2 {πσ}_{k}^{2}}} & ( 2 )\end{matrix}$$

is a one-dimensional Gaussian distribution density of mean μₖ and standard deviation σₖ, M is the number of Gaussian components in the mixture, and λₖ is the marginal probability that any sample value comes from the kth Gaussian component. It is part of methodology 100 to interpret each mixture component as a cluster. Thus, as will be described in detail below, methodology 100 first fits the data with a sum of mixtures and then determines that each mixture is a cluster.

The parameters of the Gaussian mixture, M, λₖ, μₖ, σₖ, are estimated according to the observed values of the input attribute. A variety of methods are suitable for the optimal determination of those parameters. In one embodiment, for example, the optimal Gaussian mixture is determined as follows. Given Nₑ values of the input attribute, denoted by xᵢ wherein i=1 . . . Nₑ, and for a fixed value of M, the likelihood of the Gaussian mixture m is determined as:

$$P ( \{ {x}_{i} \} \vert m ) = {\prod }_{i = 1}^{{N}_{e}} p ( {x}_{i} \vert m ) , \qquad ( 3 )$$

wherein p(xᵢ|m) is determined as in Equation 1, above. The parameters of the mixture m, {λₖ, μₖ, σₖ} are selected such that the parameters maximize the value of the likelihood by using an expectation maximization (EM) procedure. The EM procedure used together with a maximum A-posteriori (MAP) criterion ensures that the most probable Gaussian mixture is found.

After the maximum of the likelihood function is achieved, the mixture is scored by the following Bayesian information criterion (BIC) score:

$$BIC ( {m}^{*} ) = log P ( \{ {x}_{i} \} \vert {m}^{*} ) - \frac{v ( {m}^{*} )}{2} log ( {N}_{e} ) , \qquad ( 4 )$$

wherein m* is the mixture that maximized the likelihood of Equation 3, above. The quantity v(m) is the total number of free parameters required to specify the mixture model m. This BIC score is introduced in G. Schwarz, Estimating the Dimension of a Model, ANNALS OF STATISTICS, 6, 461-464 (1978), the disclosure of which is incorporated by reference herein.

The procedure evaluates the BIC(m) score on mixtures with increasing numbers of components, starting with M=1, and successively evaluating the BIC(m) score on mixtures with M=2, 3, 4, . . . . As M increases, the quantity v(m) weights negatively on the BIC(m) score, and a maximum BIC(m) is achieved at a finite value of M. The optimal mixture model selected is then the model whose number of mixture components M maximizes the BIC(m) score.

From the optimal mixture model m*, the one-dimensional clusters can be revealed. If m* is characterized by parameters {M, λₖ, μₖ, σₖ}, the method reports that M Gaussian clusters exist, each centered around μₖ, of half-width σₖ, and covering a fraction of samples λₖ.

### II. Second Phase

As described above, in phase 104, the second phase of methodology 100, subspaces are determined wherein multi-dimensional Gaussian clusters of the samples can exist, i.e., candidate subspaces. The one-dimensional Gaussian mixtures of the First Phase, described above, constitute an input to the Second Phase.

According to an exemplary embodiment, in order to determine the candidate subspaces, the one-dimensional Gaussian mixtures are converted into elementary patterns (e.g., given by the individual Gaussians in the Gaussian mixture), as in step 110. The elementary patterns are transformed into a pattern space, as in step 112. Clusters of the elementary patterns are detected in the pattern space, as in step 114. The clusters of the elementary patterns are transformed into one or more subsets of the input attributes that define the one or more subspaces, as in step 116.

Specifically, each one-dimensional Gaussian mixture is decomposed into disjoint clusters of samples as follows. Assuming that one cluster of samples exists for each Gaussian component in the mixture model, a sample with value xᵢ wherein i=1 . . . Nₑ, is assigned to cluster kth such that:

$$k = {argmax}_{j ∈ \{ 1 … M \}} \{ P ( {C}_{j} \vert {x}_{i} ) \} = {argmax}_{j ∈ \{ 1 … M \}} \{ N ( {x}_{i} \vert {μ}_{j} , {σ}_{j} ) {λ}_{j} \} , \qquad ( 5 )$$

wherein M is the number of Gaussians in the mixture, λⱼ is the marginal probability that any sample comes from Gaussian component jth and N(x₁|μⱼ,σⱼ) is a Gaussian distribution density of mean μⱼ and standard deviation σⱼ. The M Gaussian components produce M clusters of samples. These clusters, i.e., elementary patterns, are one-dimensional at this point since the values of only a single input attribute are considered.

The elementary patterns are then transformed into a pattern space, wherein each elementary pattern defines one real-valued dimension of the pattern space. Namely, each elementary pattern is represented by a vector \vec{πₖ}=(e₁, e₂, . . . , e_{N}_{ₑ}), wherein eᵢ equals “1” if sample ith belongs to the elementary cluster k as determined by Equation 5, or “0” otherwise. An alternative definition of the elementary pattern vector can be defined wherein eᵢ equals N(xᵢ|μₖ,σₖ) if sample ith belongs to the elementary cluster k as determined by Equation 5, or “0” otherwise.

A coordinate of a sample, e.g., the “1” or “0” assigned to the vector, depends on to what degree the elementary pattern contains the sample. The collection of these vectors makes up the pattern space. Namely, two techniques are described herein to define the coordinate value. The first is a discretized method wherein the coordinate value is either “1” or “0,” and the second is a continuous method wherein the coordinate value is the Gaussian density of the elementary pattern on the original attribute value of the sample. The coordinate value can further be defined in other ways, so long as the coordinate value measures the likelihood that the sample belongs to the elementary pattern.

In the Second Phase, the elementary pattern vectors are used to find subspaces where a multidimensional cluster of samples is most likely to exist. To improve tightness of the final clusters, those elementary patterns are considered that satisfy the condition σₖ≦δ, wherein σₖ is the standard deviation of the Gaussian mixture that generated the pattern and δ is a user-input parameter controlling the “width” of the elementary patterns. Tightness of a cluster indicates that the samples in the cluster are close to each other (in distance), i.e., relative to those samples outside of the cluster. Tightness is a desirable property of a cluster.

Overall, the Second Phase looks for groups of elementary patterns that agree on a common subset of the samples. This task can be performed by detecting clusters in the pattern space using an auxiliary clustering procedure, e.g., to clusters the elementary pattern vectors \vec{π}ₖ. Any suitable auxiliary clustering procedure can be employed and does not need to have subspace clustering capabilities.

According to an exemplary embodiment, the clustering of elementary patterns is performed as follows. First, the similarity of two elementary patterns is assessed by the following distance measure:

$$d ( {\vec{π}}_{1} , {\vec{π}}_{2} ) = 1 - ( \frac{{\vec{π}}_{1} \cdot {\vec{π}}_{2}}{{\vec{π}}_{1} \cdot {\vec{π}}_{1} + {\vec{π}}_{2} \cdot {\vec{π}}_{2} - {\vec{π}}_{1} \cdot {\vec{π}}_{2}} ) . \qquad ( 6 )$$

This measure determines the ratio of the number of samples in the intersection to the number of samples in the union of \vec{π₁} and \vec{π₂}. Namely, if using discrete “0” or “1” coordinates in pattern space, the dot product, i.e., the scalar product, of the pattern vectors is equivalent to the intersection of the sample sets of each elementary pattern. By way of example only, if there are five samples and two elementary pattern vectors (e.g., π₁=(1, 0, 0, 1, 1) and π₂=(0, 1, 0, 1, 1)), then their dot product π₁·π₂=1·0+0·1+0·0+1·1+1·1=2, the number of samples the two elementary patterns have in common, i.e., samples 4 and 5.

The ratio is negated so that the most similar elementary patterns produce smaller distances. The distance measured is thus always in [0, 1] and is independent of the number of samples in the compared patterns.

In order to find groups of elementary patterns with significant overlap in their sample subsets, methodology 100 executes a hierarchical clustering of all of the elementary pattern vectors \vec{πᵢ} using the above-defined distance. Hierarchical clustering is described, for example, in S.C. Johnson, Hierarchical Clustering Schemes, PSYCHOMETRIKA 32, 241-254 (1967), the disclosure of which is incorporated by reference herein. The distances among clusters of elementary patterns are computed by average linkage.

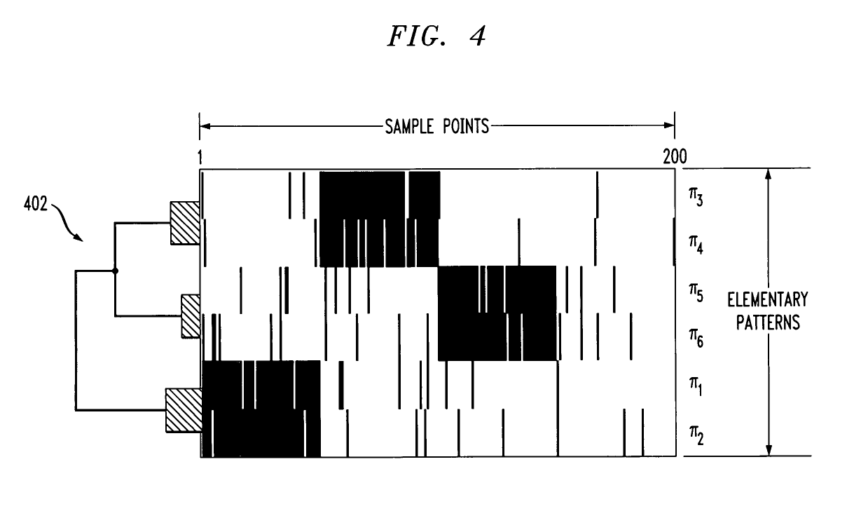

The hierarchical clustering produces a dendrogram, or tree graph, where each internal node always has two children, and each internal node represents a cluster of elementary patterns. A dendrogram is shown, for example, in FIG. 4, described below. As will also be described below, FIG. 4 highlights those clusters with silhouette scores of at least 0.5, that contain at least two elementary patterns and that contain as many elementary patterns as possible.

Next, a selection is made of those clusters of elementary patterns having the best quality, as defined by the following silhouette score of the elementary pattern cluster:

$$\begin{matrix}Sil ( C ) = \frac{{\sum }_{j ∈ C} Sil ( {\vec{π}}_{j} , C )}{\vert C \vert} & ( 7 ) \\ Sil ( {\vec{π}}_{j} , C ) = \frac{{b}_{j} - {a}_{j}}{max ( {b}_{j} , {a}_{j} )} & ( 8 ) \\ {b}_{j} = \frac{{\sum }_{k ∉ C} d ( {\vec{π}}_{k} , {\vec{π}}_{j} )}{\vert P - C \vert} {a}_{j} = \frac{{\sum }_{k ∈ C} d ( {\vec{π}}_{k} , {\vec{π}}_{j} )}{\vert C \vert} , & ( 9 )\end{matrix}$$

wherein P is the set of all elementary patterns and C is the set of elementary patterns in the cluster under consideration. Silhouette scores are in [−1, 1], with poorly defined clusters scoring close to −1, and well-defined clusters scoring close to +1. The clusters with a silhouette score above a threshold parameter τ are selected for the next phase of methodology 100.

### III. Third Phase

As described above, in phase 106, the third phase of methodology 100, multivariate clusters are detected in the candidate subspaces determined in the Second Phase. According to an exemplary embodiment, as shown in step 118, the multivariate Gaussian clusters can be detected by approximating a probability density with a weighted sum of multi-dimensional Gaussian distributions.

Specifically, the clusters of elementary patterns selected by the auxiliary clustering procedure of the Second Phase are converted into groups of attributes. Each attribute group is made up of the attributes which contained an elementary pattern in the same elementary pattern cluster. It is expected that these groups of attributes define subspaces wherein good quality clusters of sample points can be found. Effectively, the dimensionality has been reduced to a few sets of attributes. In the Third Phase, each group of attributes is analyzed in turn to find clusters of samples in the subspace defined by such attributes.

To detect multivariate Gaussian clusters in the candidate subspaces, the clusters found in the pattern space are translated into subspaces of the original input dimensions. Namely, for each group of attributes the data is projected into the subspace defined by said group of attributes, i.e., attributes that do not belong to the attribute group under consideration are ignored.

Multi-dimensional Gaussian clusters are then detected. The multi-dimensional Gaussian clusters can be detected by modeling the probability density of the data values in the subspace as a weighted sum of Gaussian distributions. Namely, the data projected into the subspace is modeled by a multi-dimensional Gaussian mixture. In contrast to what was done in the First Phase where Gaussian mixtures were applied to a single attribute, in the Third Phase Gaussian mixtures are applied in the possibly high-dimensional subspace defined by a group of attributes. Further, as will be described in detail below, the most probable Gaussian mixture is found by using the EM algorithm together with a MAP criterion.

The multi-dimensional Gaussian mixture is defined as:

$$p ( \vec{x} ) = {\sum }_{k = 1}^{{M}_{s}} {λ}_{k} N ( \vec{x} \vert {\vec{μ}}_{k} , {Σ}_{k} ) . \qquad ( 10 )$$

Each Gaussian mixture component is a multi-dimensional Gaussian distribution of density:

$$N ( \vec{x} \vert {\vec{μ}}_{k} , {Σ}_{k} ) = \frac{exp ( - {( \vec{x} - {\vec{μ}}_{k} )}^{t} {Σ}_{k}^{- 1} ( \vec{x} - {\vec{μ}}_{k} ) / 2 )}{\sqrt{{( 2 π )}^{d} \vert {Σ}_{k} \vert}} , \qquad ( 11 )$$

wherein Σₖ is the covariance matrix, |Σₖ| is its determinant, \vec{μₖ} is the mean, and d is the number of dimensions of the Gaussian mixture component k. Mₛ is the number of Gaussian components of the mixture in the subspace, λₖ is the marginal probability that any sample value comes from the kth Gaussian component. The parameters of the Gaussian mixture, Mₛ, λₖ, \vec{μₖ}, Σₖ, need to be estimated according to the observed values of the d attributes in the group of attributes under analysis. Any suitable method for the optimal determination of those parameters may be employed.

For example, according to one exemplary embodiment, the optimal multi-dimensional Gaussian mixture is determined as follows. Similar to the First Phase, given Nₑ data sample points in the subspace defined by d attributes, each sample point is represented by a vector \vec{xᵢ} wherein i=1 . . . Nₑ, and for a fixed value of Mₛ, the likelihood of the Gaussian mixture m is computed as:

$$P ( \{ {\vec{x}}_{i} \} \vert m ) = {\prod }_{i = 1}^{{N}_{e}} p ( {\vec{x}}_{i} \vert m ) , \qquad ( 12 )$$

wherein p(\vec{xᵢ}|m) is determined as in Equation 10, above. The parameters of the mixture m, {λₖ, \vec{μₖ}, Σₖ} are selected such that they maximize the value of the likelihood by using the EM procedure.

After the maximum of the likelihood function is achieved, the mixture is scored by the following BIC score:

$$BIC ( {m}^{*} ) = log P ( \{ {\vec{x}}_{i} \} \vert {m}^{*} ) - \frac{v ( {m}^{*} )}{2} log ( {N}_{e} ) , \qquad ( 13 )$$

wherein m* is the mixture that maximized the likelihood of Equation 12, above. The quantity v(m) is the total number of free parameters required to specify the mixture model m. The procedure evaluates the BIC(m) score on mixtures with an increasing number of components, starting with Mₛ=1, and successively evaluating the BIC(m) score on mixtures with Mₛ=2, 3, 4, . . . .

As Mₛ increases, the quantity v(m) weights negatively on the BIC(m) score and a maximum BIC(m) is achieved at a finite value of Mₛ. The optimal mixture model selected then is the model whose number of mixture components Mₛ maximizes the BIC(m) score.

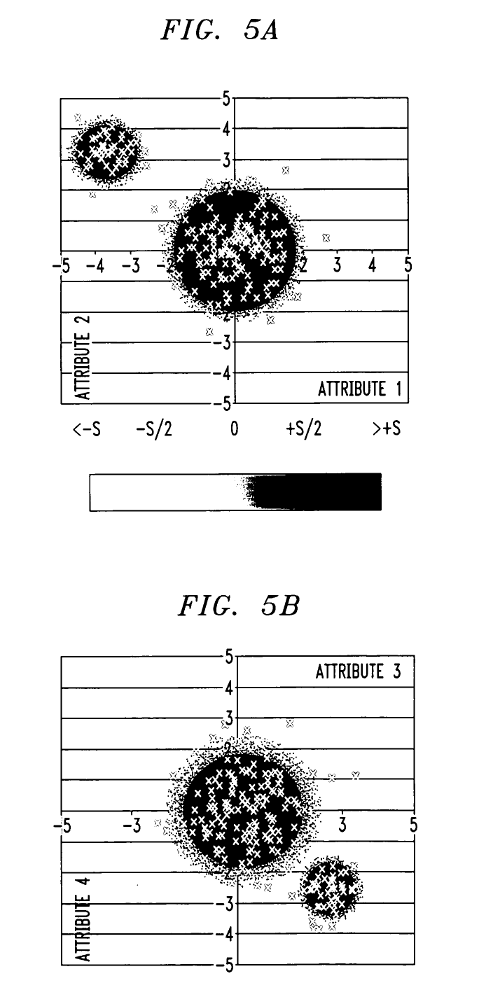

The multi-dimensional subspace clusters are extracted from the optimal mixture model m*. Plots of optimal two-dimensional mixture densities for the candidate subspaces of the example data set are shown in FIG. 5, described below. If for a given attribute set m* is characterized by parameters {Mₛ, λₖ, \vec{μₖ}, Σₖ}, the method reports that Mₛ Gaussian subspace clusters exist, each centered around \vec{μₖ} of covariance Σₖ, and covering a fraction of sample points λₖ. The sample points \vec{xᵢ} wherein i=1 . . . Nₑ are assigned to subspace cluster kth by the following equation:

$$k = {argmax}_{j ∈ \{ 1 … {M}_{s} \}} \{ P ( {C}_{j} \vert {\vec{x}}_{i} ) \} = {argmax}_{j ∈ \{ 1 … {M}_{s} \}} \{ N ( {\vec{x}}_{i} \vert {\vec{μ}}_{j} , {Σ}_{j} ) {λ}_{j} \} , \qquad ( 14 )$$

wherein P(Cⱼ|\vec{xᵢ}) is the probability that sample \vec{xᵢ} belongs to subspace cluster Cⱼ. The Mₛ multi-dimensional Gaussian subspace clusters thus determined, together with the sample point-to-cluster assignment constitute the final result of methodology 100 that can be reported to a user.

Thus, methodology 100 provides a subspace clustering technique that automatically finds subspaces of the highest possible dimensionality in a data space, such that multi-dimensional Gaussian clusters exist in those subspaces. The cluster-containing subspaces of high-dimensional data are identified without requiring the user to guess subspaces that might have interesting clusters. Further, methodology 100 provides identical results irrespective of the order in which input records are presented.

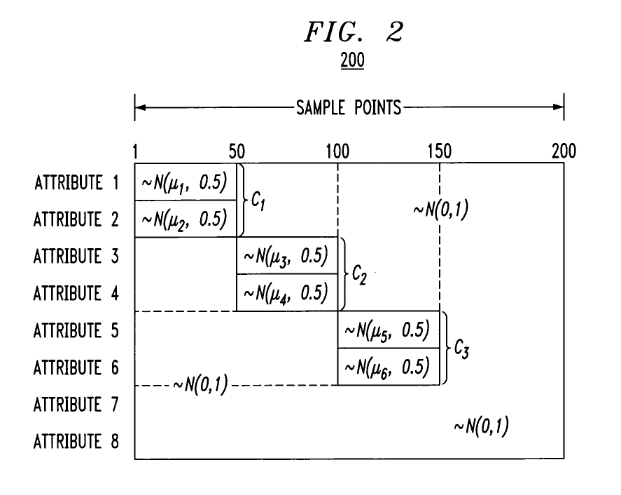

FIG. 2 is a diagram illustrating exemplary synthetic data set 200. Synthetic data set 200 may be used, for example, with methodology 100, described in conjunction with the description of FIG. 1, above. As shown in FIG. 2, three subspace clusters C₁, C₂, C₃ are synthetically inserted in the data. Data in each sub-region of the data set are sampled according to Gaussian distributions N(μ, σ), with mean μ and standard deviation σ, as shown. Data set 200 illustrates how methodology 100 works by recovering the synthetically inserted subspace clusters.

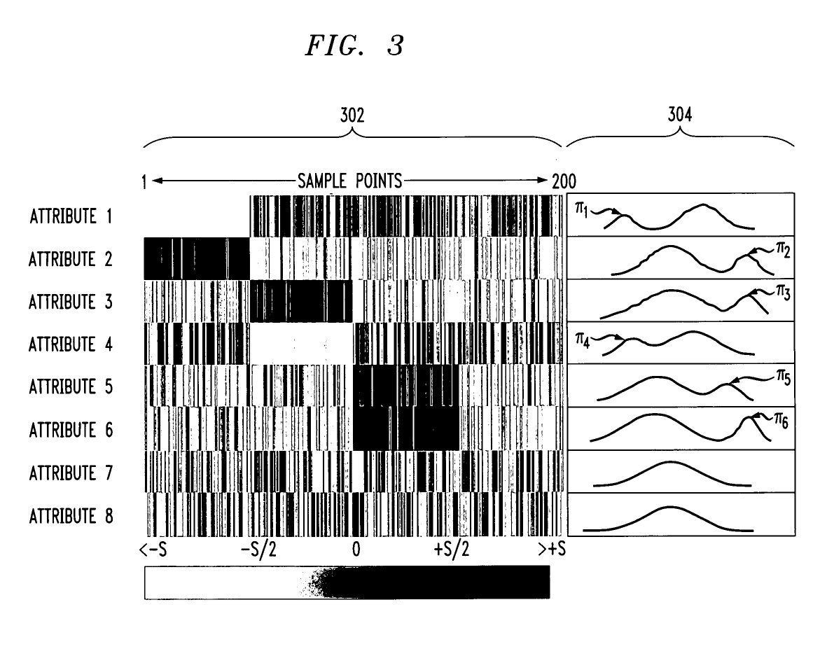

FIG. 3 is a plot illustrating optimal mixture densities for each input attribute of exemplary data set 200 of FIG. 2. In section 302, the values of each input attribute are represented by a gray scale, wherein darker shades indicate higher values and lighter shades indicate lower values. Each row represents one attribute. Each column represents one sample point.

In section 304, the estimated Gaussian mixture probability densities for each attribute are shown. Elementary patterns are detected for attributes 1 to 6 as a result of decomposing the Gaussian mixture corresponding to the attributes. The densities for attributes 7 and 8 cannot be decomposed, and hence produce no elementary patterns.

FIG. 4 is a diagram illustrating clustering of elementary patterns in a pattern space by an auxiliary clustering procedure. Hierarchical clustering, as described, for example, in conjunction with the description of FIG. 1, above, produces dendrogram (or tree graph) 402 wherein each internal node always has two children, as shown in FIG. 4. Each internal node in the dendrogram represents a cluster of elementary patterns.

Sample points are represented in the pattern space by either a “0” if the sample point does not belong to the elementary pattern or a “1” otherwise. A “0” is presented in white, and a “1” is presented in black. As described above, FIG. 4 highlights those clusters with silhouette scores of at least 0.5, that contain at least two elementary patterns and that contain as many elementary patterns as possible, namely clusters {π₃, π₄}, {π₅, π₆} and {π₁, π₂}. These three clusters identify three candidate subspaces defined by attributes {3, 4}, {5, 6} and {1, 2}, respectively, e.g., of data set 200.

FIGS. 5A-C are plots illustrating multi-dimensional Gaussian mixtures for the candidate subspaces shown identified in FIG. 4. Specifically, FIG. 5A is a plot illustrating multi-dimensional Gaussian mixtures for candidate subspace {1, 2}, FIG. 5B is a plot illustrating multi-dimensional Gaussian mixtures for candidate subspace {3, 4} and FIG. 5C is a plot illustrating multi-dimensional Gaussian mixtures for candidate subspace {5, 6}.

In FIGS. 5A-C, the optimal multi-dimensional Gaussian mixture density, e.g., as determined by the Third Phase of methodology 100, described in conjunction with the description of FIG. 1, above, is represented by a gray scale, wherein darker shades represent higher density values and lighter shades represent lower density values. The original input data is superposed as white points. Each Gaussian mixture is two-dimensional for this sample data and can be decomposed into two clusters, wherein one of the clusters corresponds to one of the synthetically inserted subspace clusters shown in FIG. 2.

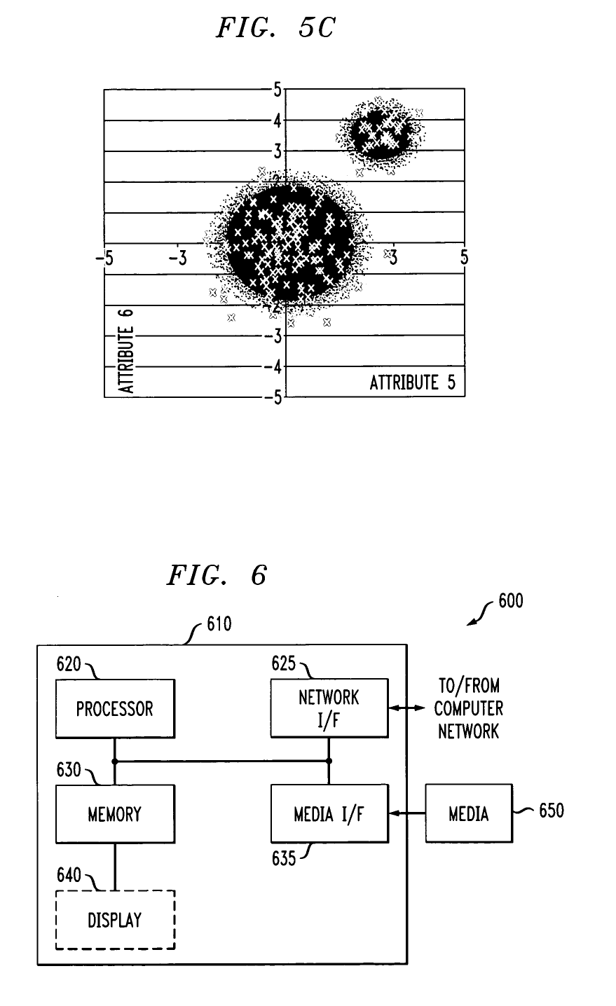

Turning now to FIG. 6, a block diagram is shown of an apparatus 600 for finding clusters in a database, in accordance with one embodiment of the present invention. The database contains a plurality of input attributes associated with a plurality of samples. It should be understood that apparatus 600 represents one embodiment for implementing methodology 100 of FIG. 1.

Apparatus 600 comprises a computer system 610 and removable media 650. Computer system 610 comprises a processor 620, a network interface 625, a memory 630, a media interface 635 and an optional display 640. Network interface 625 allows computer system 610 to connect to a network, while media interface 635 allows computer system 610 to interact with media, such as a hard drive or removable media 650.

As is known in the art, the methods and apparatus discussed herein may be distributed as an article of manufacture that itself comprises a machine-readable medium containing one or more programs which when executed implement embodiments of the present invention. For instance, the machine-readable medium may contain a program configured to detect one-dimensional clusters for each of one or more of the input attributes in the database; use the one-dimensional clusters to determine one or more subspaces wherein at least one multi-dimensional cluster of the samples can exist; and detect one or more multivariate clusters in the one or more subspaces.

The machine-readable medium may be a recordable medium (e.g., floppy disks, hard drive, optical disks such as removable media 650, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor 620 can be configured to implement the methods, steps, and functions disclosed herein. The memory 630 could be distributed or local and the processor 620 could be distributed or singular. The memory 630 could be implemented as an electrical, magnetic or optical memory, or any combination of these or other types of storage devices. Moreover, the term “memory” should be construed broadly enough to encompass any information able to be read from, or written to, an address in the addressable space accessed by processor 620. With this definition, information on a network, accessible through network interface 625, is still within memory 630 because the processor 620 can retrieve the information from the network. It should be noted that each distributed processor that makes up processor 620 generally contains its own addressable memory space. It should also be noted that some or all of computer system 610 can be incorporated into an application-specific or general-use integrated circuit.

Optional video display 640 is any type of video display suitable for interacting with a human user of apparatus 600. Generally, video display 640 is a computer monitor or other similar video display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for finding clusters in a database containing a plurality of input attributes associated with a plurality of samples, the method comprising the steps of:
detecting one-dimensional clusters for each of one or more of the input attributes in the database;
using the one-dimensional clusters to determine one or more subspaces wherein at least one multi-dimensional cluster of the samples can exist; and
detecting one or more multivariate clusters in the one or more subspaces.

2. The method of claim 1, wherein the input attributes comprise values corresponding to one or more of the samples in the database.

3. The method of claim 1, wherein each of the input attributes comprises a gene.

4. The method of claim 1, wherein each of the samples comprises a medical patient.

5. The method of claim 1, further comprising the step of:
using the one-dimensional clusters to determine one or more candidate subspaces wherein at least one multi-dimensional cluster of the samples is most likely to exist.

6. The method of claim 1, wherein the one-dimensional clusters are detected for each and all of the input attributes in the database.

7. The method of claim 1, wherein the step of detecting one-dimensional clusters further comprises the step of:
approximating a probability density with a weighted sum of Gaussian distributions.

8. The method of claim 1, wherein the step of using the one-dimensional clusters to determine the one or more subspaces further comprises the steps of:
converting the one-dimensional clusters into elementary patterns;
transforming the elementary patterns into a pattern space;
detecting clusters of the elementary patterns in the pattern space; and
transforming the clusters of the elementary patterns into one or more subsets of the input attributes that define the one or more subspaces.

9. The method of claim 8, wherein the step of transforming the elementary patterns into a pattern space further comprises the steps of:
representing each of the elementary patterns with a vector;
assigning a “1” to the vector for each sample belonging to a corresponding one of the elementary patterns; and
assigning a “0” to the vector for each sample not belonging to a corresponding one of the elementary patterns.

10. The method of claim 8, wherein the step of transforming the elementary patterns into a pattern space further comprises the steps of:
representing each of the elementary patterns with a vector;
assigning N(xᵢ|μₖ,σₖ) to the vector for each sample belonging to a corresponding one of the elementary patterns; and
assigning a “0” to the vector for each sample not belonging to a corresponding one of the elementary patterns.

11. The method of claim 1, wherein the step of detecting one or more multivariate clusters in the one or more subspaces further comprises the step of:
approximating a probability density with a weighted sum of multi-dimensional Gaussian distributions.

12. A method for finding Gaussian clusters in a database containing a plurality of input attributes associated with a plurality of samples, the method comprising the steps of:
detecting one-dimensional Gaussian clusters for each of one or more of the input attributes in the database;
using the one-dimensional Gaussian clusters to determine one or more subspaces wherein at least one multi-dimensional Gaussian cluster of the samples can exist; and
detecting one or more multivariate Gaussian clusters in the one or more subspaces.

13. An apparatus for finding clusters in a database containing a plurality of input attributes associated with a plurality of samples, the apparatus comprising:
a memory; and
at least one processor, coupled to the memory, operative to:
detect one-dimensional clusters for each of one or more of the input attributes in the database;
use the one-dimensional clusters to determine one or more subspaces wherein at least one multi-dimensional cluster of the samples can exist; and
detect one or more multivariate clusters in the one or more subspaces.

14. The apparatus of claim 13, wherein the at least one processor, operative to detect one-dimensional clusters for each of one or more of the input attributes in the database, is further operative to:
approximate a probability density with a weighted sum of Gaussian distributions.

15. The apparatus of claim 13, wherein the at least one processor, operative to use the one-dimensional clusters to determine the one or more subspaces wherein at least one multi-dimensional cluster of the samples can exist, is further operative to:
convert the one-dimensional clusters into elementary patterns;
transform the elementary patterns into a pattern space;
detect clusters of the elementary patterns in the pattern space; and
transform the clusters of the elementary patterns into one or more subsets of the input attributes that define the one or more subspaces.

16. The apparatus of claim 13, wherein the at least one processor, operative to detect one or more multivariate clusters in the one or more subspaces, is further operative to:
approximate a probability density with a weighted sum of multi-dimensional Gaussian distributions.

17. An article of manufacture for finding clusters in a database containing a plurality of input attributes associated with a plurality of samples, comprising a machine-readable medium containing one or more programs which when executed implement the steps of:
detecting one-dimensional clusters for each of one or more of the input attributes in the database;
using the one-dimensional clusters to determine one or more subspaces wherein at least one multi-dimensional cluster of the samples can exist; and
detecting one or more multivariate clusters in the one or more subspaces.

18. The article of manufacture of claim 17, wherein the step of detecting one-dimensional clusters further comprises the step of:
approximating a probability density with a weighted sum of Gaussian distributions.

19. The article of manufacture of claim 17, wherein the step of using the one-dimensional clusters to determine the one or more subspaces wherein at least one multi-dimensional cluster of the samples can exist, further comprises the steps of:
converting the one-dimensional clusters into elementary patterns;
transforming the elementary patterns into a pattern space;
detecting clusters of the elementary patterns in the pattern space; and
transforming the clusters of the elementary patterns into one or more subsets of the input attributes that define the one or more subspaces.

20. The article of manufacture of claim 17, wherein the step of detecting one or more multivariate clusters in the one or more subspaces further comprises the step of:
approximating a probability density with a weighted sum of multi-dimensional Gaussian distributions.
